(19) United States
(12) Patent Application Publication
(10) Pub. No.: US 2005/0086054 A1
(43) Pub. Date: Apr. 21, 2005

(54) ADPCM encoding and decoding method and system with improved step size adaptation thereof

(76) Inventor: Yen-Shih Lin, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/964,658

(22) Filed: Oct. 15, 2004

(30) Foreign Application Priority Data
Oct. 16, 2003 (TW) 092128759

(51) Int. Cl. G10L 19/02

(52) U.S. Cl. 704/229

(57) ABSTRACT

An ADPCM method and system comprise dividing a voice signal into a plurality of frames, pre-coding for each of the frames for determining a suitable step size modulation function and maximum step size that will induce better SNR for the frame it is corresponding to, and encoding for each of the frames with its respective suitable step size modulation function and maximum step size. The quality of the processed voice signal is therefore improved and the quantization error thereof is minimized.

### FIELD OF THE INVENTION

The present invention relates generally to an adaptive differential pulse code modulation (ADPCM), and more particularly, to an ADPCM method and system with improved step size adaptation thereof for encoding and decoding a voice signal.

### BACKGROUND OF THE INVENTION

FIG. 1 is a simplified system block diagram of a conventional ADPCM encoder 10 composed of two combiners 11 and 13, a quantizer 12, a predictor 14 and a step size modulator 16. The quantizer 12 quantizes a differential signal ΔX[n] to generate a digital code C[n] and a quantized differential signal ΔX′[n], where the differential signal ΔX[n] is provided by a combiner 11 that represents the difference between a voice signal X[n] and a predicted signal X′[n]. The combiner 13 combines the quantized differential signal ΔX′[n] and the predicted signal X′[n] to generate a signal S for the predictor 14 to generate the next predicted signal X′[n+1], and the step size modulator 16 provides a step size modulation function M(C[n]) based on the digital code C[n] for the quantization of the next input ΔX[n+1] of the quantizer 12.

Corresponding to the ADPCM encoder 10 shown in FIG. 1, FIG. 2 is a simplified system block diagram of a conventional ADPCM decoder 20 composed of a dequantizer 22, a predictor 24, a combiner 25, and a step size modulator 26. The step size modulator 26 receives a digital code C[n] to provide a step size modulation function M(C[n]) for the dequantizer 22 to dequantize the digital code C[n] to generate a differential signal ΔX[n] that is further combined with a predicted signal X′[n] by the combiner 25 to recover a voice signal X[n], and the predictor 24 generates the predicted signal X′[n] according to the previous recovered voice signal X[n−1].

The quantizer 12 of the ADPCM encoder 10 is regulated by the step size modulation function M(C[n]) to adjust the step size step_size(n) thereof, so as to be adaptive to the variation of the current differential signal ΔX[n]. However, in the process to update the step size step_size(n) in the quantizer 12, which is based on the current coded data to determine the next step size step_size(n+1), it is usually generated by
step_size(n+1)=step_size(n)×M(C[n]). [Eq-1]

The step size modulation function M(C[n]) depends solely on the current digital code C[n]. Generally, there are look-up tables between the step size modulation function M(C[n]) and digital code C[n] stored in the step size modulators 16 and 26, respectively, as shown in Table 1 for example, and the values of the tables are predetermined and not adaptive to the characteristics of the processed signals. Accordingly, when the amplitude of a voice signal is varied much larger, the corresponding step size modulation function M(C[n]) could not achieve optimized processing of the voice signal, thereby causing the processed signal more serious distortion.

TABLE 1

| Digital Code C[n] | Step Size Modulation function M(C[n]) |
|---|---|
| 0, 1, 2, 3, 8, 9, 10, 11 | 0.9 |
| 4, 12 | 1.2 |
| 5, 13 | 1.6 |
| 6, 14 | 2.0 |
| 7, 15 | 2.4 |

Referring to Table 1, C[n] represents four bit data, and the rule shows when C[n] is 0, 1, 2, 3, 8, 9, 10 or 11, M(C[n]) is 0.9, when C[n] is 4 or 12, M(C[n]) is 1.2, when C[n] is 5 or 13, M(C[n]) is 1.6, when C[n] is 6 or 14, M(C[n]) is 2.0, and when C[n] is 7 or 15, M(C[n]) is 2.4. In Table 1, different values of the digital code C[n] will map to respective constant values of the step size modulation function M(C[n]), i.e., it is independent on the property of the processed signal itself.

Furthermore, there is always a maximum value for the step size predetermined in the conventional ADPCM encoder 10 to prevent the processed signal from distortion induced by large step size. There is also only one for this maximum step size for various voice signals or various segments of a voice signal. However, a voice signal may vary in amplitude varying range and speed at every time points, and a wider range requires a wider step size, while a smaller range requires a smaller step size, and thus a single constant maximum step size could not fulfill all the ranges of the voice signal.

Therefore, it is desired an ADPCM encoding method and system having various maximum step sizes and step size modulation functions for improved signal-to-noise ratio (SNR) depending on different ranges of the processed signal.

### SUMMARY OF THE INVENTION

An object of the present invention is to provide an ADPCM method and system for a voice signal to improve the step size adaptation thereof.

Another object of the present invention is to provide an ADPCM method and system capable of dynamically determining a suitable step size modulation function and maximum step size for a processed signal by a pre-coding process.

Yet another object of the present invention is to provide an ADPCM method and system to improve the encoding performance and to prevent the processed signal from distortion induced by large step size.

According to the present invention, an ADPCM encoding method and system comprise dividing a voice signal into a plurality of frames, pre-coding for each of the frames for determining a suitable step size modulation function and maximum step size that will induce better SNR for the frame it is corresponding to, and encoding for each of the frames with its respective suitable step size modulation function and maximum step size.

According to the present invention, an ADPCM decoding method and system comprise dequantizing a received digital code to be a difference signal with a suitable step size modulation function and maximum step size corresponding to the frame that the received digital code belongs to, and combining the difference signal with a predicted signal to thereby generate a voice signal.

A voice signal is inherently varied slowly, and it will not change violently within a short time period, i.e., each point of the signal has nearly property with its neighborhood. It is therefore advantageous to divide a voice signal into a plurality of frames, and a frame becomes the unit for encoding adaptation. Moreover, by the pre-coding process to determine the suitable step size modulation function and maximum step size for each frame of the processed signal in advance, optimized voice quality can be obtained after the determined suitable step size modulation functions and maximum step sizes are used in the encoding process one by one for the frames, and the quantization error will be minimized.

After the pre-coding process, the most suitable step size modulation functions and maximum step sizes of the frames are stored in a look-up table, and by looking up to the table, the step size modulation function and maximum step size of the ADPCM encoding system will vary frame by frame. Therefore, the ADPCM encoding/decoding system of the present invention is adaptive to the respective characteristics of the processed voice signals to prevent them from distortion and to improve their voice quality.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a simplified system block diagram of a conventional ADPCM encoder;

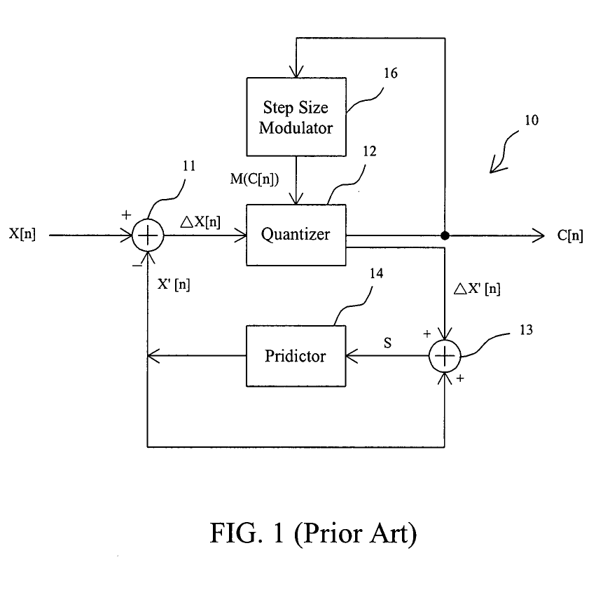

FIG. 2 is a simplified system block diagram of a conventional ADPCM decoder;

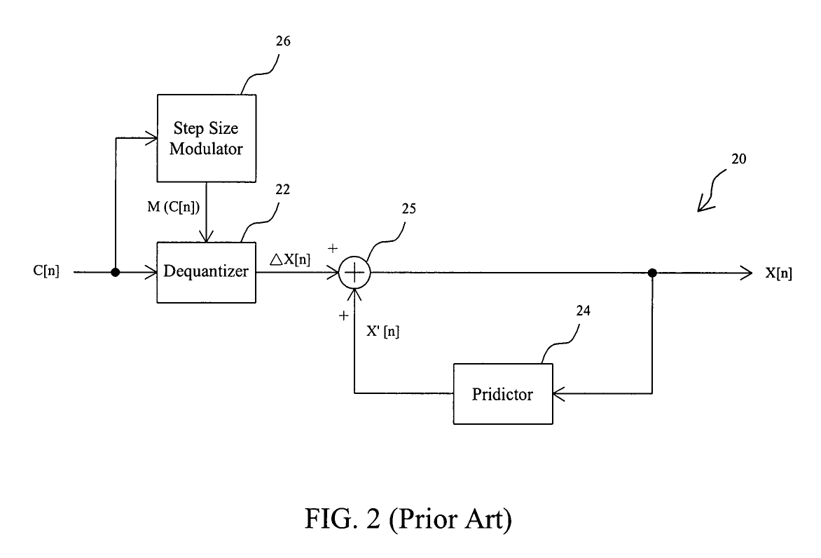

FIG. 3 shows a waveform of an ordinary voice signal;

FIG. 4 is a flowchart of an ADPCM encoding method according to the present invention;

FIG. 5 is a simplified system block diagram of an ADPCM encoder according to the present invention; and

FIG. 6 is a simplified system block diagram of an ADPCM decoder according to the present invention.

### DETAILED DESCRIPTION OF THE INVENTION

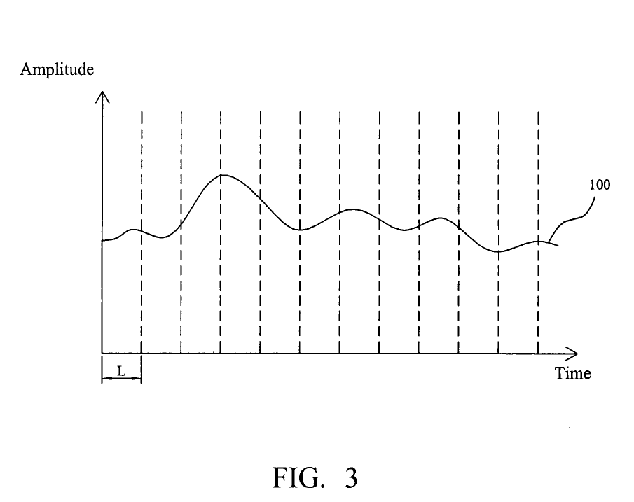

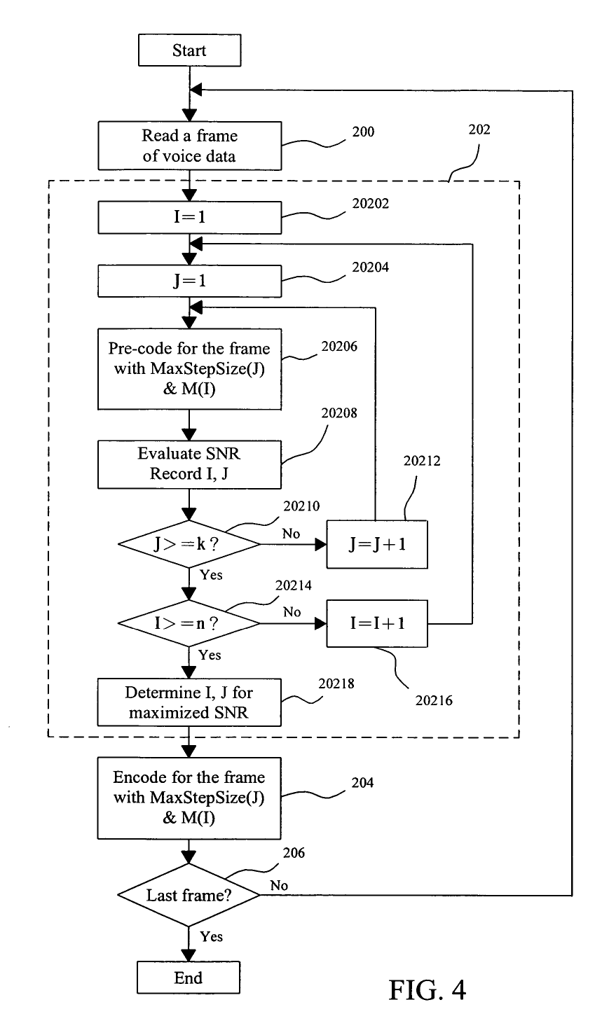

FIG. 3 shows a waveform of an ordinary voice signal 100, which has the property of miner variation within a short time period for the inherent characteristics of a voice signal. The signal 100 is divided into a plurality of frames, each of them has very similar signal characteristics thereof, and the signal within a frame can be encoded with a same step size modulation function without introducing much distortion. In this embodiment, for simplicity, the length of each frame is L. In alternative embodiments, however, the frame length L of the voice signal 100 can be variable for example according to the amplitude range and variation of the voice signal 100. With a frame as a unit, the signal 100 is pre-coded in advance and formal encoded thereafter, as shown in the flowchart of FIG. 4. In this embodiment, there are k given maximum step sizes, MaxStepSize(1), MaxStepSize(2), . . . , MaxStepSize(k), in order of from small to large, and n given step size modulation functions, M(1), M(2), . . . , M(n), for each frame to select the most suitable maximum step size and step size modulation function therefrom. Referring to FIG. 4, after beginning the process, in step 200 a frame of voice data is read, and this frame of voice data is pre-coded in step 202 to determine a step size modulation function M(I) and maximum step size MaxStepSize(J) that are most suitable for this frame. After the suitable step size modulation function M(I) and maximum step size MaxStepSize(J) are determined, the frame is encoded formally in step 204 with the determined step size modulation function M(I) and maximum step size MaxStepSize(J). Step 206 is performed to decide whether the frame is the last one, and if it is, the encoding process is stopped, otherwise it will return to step 200 to perform pre-coding and formal encoding for the next frame as in the previously described steps 200-204.

In the pre-coding step 202, to determine the most suitable maximum step size MaxStepSize(J) and step size modulation function M(I) from the given k maximum step sizes and n step size modulation functions, I=1 and J=1 are assigned in steps 20202 and 20204. In step 20206, MaxStepSize(J=1) as the step size and M(I=1) as the step size modulation function, the frame of voice data is pre-coded, and then, in step 20208, the SNR of the pre-coded result is evaluated, and the values of I and J (both 1) are recorded. In step 20210, it is to determine whether the value of J is larger than or equal to k, and if no, it will jump to step 20212 to have the value of J increased with 1 to further repeat steps 20206 to 20210, otherwise it goes to step 20214 to determine whether the value of I is larger than or equal to n. In step 20214, if the value of I is larger than or equal to n, it goes to step 20218 to stop the pre-coding of the current frame, otherwise it jumps to step 20216 have the value of I increased with 1 to further repeat steps 20204 to 20214. After the pre-coding of the current frame is completed in step 20214, the values of I and J that will induce the maximum SNR for the current frame are determined, and the M(I) and MaxStepSize(J) for the maximum SNR are determined to be the suitable step size modulation function and maximum step size for the current frame. Each time the step 202 is completed, a frame is given a suitable step size modulation function M(I) and maximum step size MaxStepSize(J), and after each frame is applied thereto with the steps 200-204, the encoding process is completed. By this manner, each frame is encoded with a respective step size modulation function M(I) and maximum step size MaxStepSize(J) that are adaptive to the characteristics of this coded frame. As a result, in addition to the step size modulation function adaptive to the differential signal ΔX[n], it is also adaptive to the characteristics of each frame with the step size modulation function and maximum step size. Therefore, an ADPCM code most suitable to the specific voice signal is obtained.

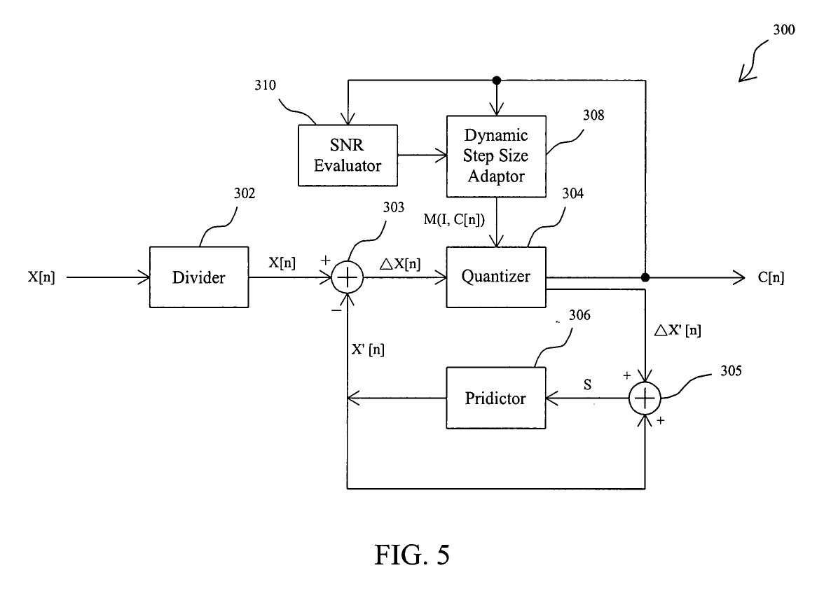

FIG. 5 is a simplified system block diagram of an ADPCM encoder 300 according to the present invention. A voice signal X[n] to be encoded is divided into a plurality of frames by a divider 302 in advance, and a counter (not shown) can be used associated with the divider 302 to record the length of the frame. A quantizer 304 quantizes the differential signal ΔX[n] to generate a digital code C[n] and a quantized differential signal ΔX′[n]. The differential signal ΔX[n] is still the difference between the voice signal X[n] and a predicted signal X′[n] produced by a combiner 303, and a combiner 305 combines the quantized differential signal ΔX′[n] and the predicted signal X′[n] to generate a signal S for a predictor 306 to generate the next predicted signal X′[n+1]. A dynamic step size adaptor 306 provides a step size modulation function M(I,C[n]) based on the previous digital code C[n−1] for the quantizer 304 to adjust the step size thereof. While pre-coding the frames of the voice signal X[n] one by one, the dynamic step size adaptor 308 provides various step size modulation functions and maximum step sizes for the quantizer 304 to quantize the respective frames. An SNR evaluator 310 evaluates the SNR value for each of the given step size modulation functions and maximum step sizes, among them, a most suitable step size modulation function M(I) and maximum step size MaxStepSize(J) will be selected therefrom for each frame. As a result, the look-up table between the step size modulation functions M(I,C[n]) and digital codes C[n] finally determined by the dynamic step size adaptor 308 is also a function of frame. Referring to FIG. 3, the amplitude varying range and variation of the signal 100 are different frame by frame, and thus the selected step size modulation function M(I,C[n]) and maximum step size MaxStepSize(J) will be also different frame by frame. Since each frame has its most suitable step size modulation function M(I,C[n]) and maximum step size MaxStepSize(J) that are determined by evaluating its SNR in advance in the pre-coding process, distortion during the encoding process can be reduced and the quality of the coded voice signal is improved. Based on the current coded data and frame, the system 300 determines the next step size by
step_size(n+1)=step_size(n)×M(I,C[n]) [Eq-2]
where step_size(n) is the current step size, and step_size(n+1) is the next step size.

The system 300 shown in FIG. 5 can be implemented on the current hardware by employing software process control, and therefore, the frame length L, step size modulation function M(I,C[n]), and maximum step size MaxStepSize(J) can be easily varied or modified to be adaptive to various voice signal X[n].

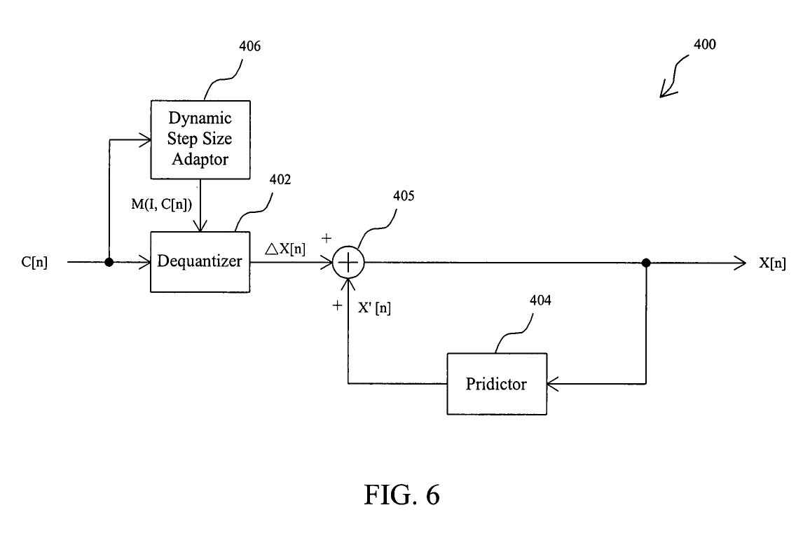

FIG. 6 is a simplified system block diagram of an ADPCM decoder 400 according to the present invention. A dynamic step size adaptor 406 provides the suitable step size modulation function M(I,C[n]) based on a digital code C[n] for the dequantizer 402 to dequantize the digital code C[n] to generate a differential signal ΔX[n]. The step size modulation function M(I,C[n]) is a function of the voice data and frame. The differential signal ΔX[n] is combined with a predicted signal X′[n] by a combiner 405 to recover the voice signal X[n]. A predictor 404 generates the next predicted signal X′[n+1] according to the current voice signal X[n]. Similarly, the look-up table between the step size modulation functions M(I,C[n]) and digital codes C[n] used by the dynamic step size adaptor 406 will vary with the voice signal X[n] and frame.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

1. An ADPCM encoding method for a voice signal, comprising the steps of:
dividing the voice signal into a plurality of frames;
pre-coding for each of the plurality of frames for determining a respective step size modulation function and maximum step size for each of the plurality of frames; and
encoding for each of the plurality of frames with the determined respective step size modulation function and maximum step size.

2. The method of claim 1, wherein the step of pre-coding for each of the plurality of frames comprises:
evaluating a signal-to-noise ratio for each of the plurality of frames under a plurality of given step modulation functions and maximum step sizes; and
selecting a step size modulation function and maximum step size from the plurality of given step modulation functions and maximum step sizes having an maximized signal-to-noise ratio to be the determined step size modulation function and maximum step size.

3. The method of claim 1, wherein the step of dividing the voice signal into a plurality of frames comprises dividing the voice signal with a constant frame length.

4. The method of claim 1, wherein the step of dividing the voice signal into a plurality of frames comprises dividing the voice signal with a varied frame length.

5. An ADPCM encoding system comprising:
a divider for dividing a voice signal into a plurality of frames with a frame length;
a quantizer for quantizing the difference between the voice signal and a predicted signal to thereby generate a digital code; and
a dynamic step size adaptor for providing a respective step size modulation function and maximum step size for the quantizer for each of the plurality of frames.

6. The system of claim 5, wherein the frame length is constant.

7. The system of claim 5, wherein the frame length is varied.

8. The system of claim 5, further comprising an SNR evaluator for evaluating a signal-to-noise ratio for each of the plurality of frames under a plurality of given step modulation functions and maximum step sizes, to thereby determine the respective step size modulation function and maximum step size for the dynamic step size adaptor.

9. The system of claim 5, wherein each of the plurality of frames has a respective step size modulation function and maximum step size to induce a maximized signal-to-noise ratio.

10. An ADPCM decoding system for generating a voice signal from a received digital code, the system comprising:
a dequantizer for dequantizing the received digital code to be a differential signal;
a combiner for combining the differential signal with a predicted signal to thereby generate the voice signal; and
a dynamic step size adaptor for providing a respective step size modulation function and maximum step size for the dequantizer for each of a plurality of frames of the voice signal.

11. The system of claim 10, wherein the respective step size modulation function and maximum step size will induce a maximized signal-to-noise ratio among a plurality of given step modulation functions and maximum step sizes for the frame it is corresponding to.
